(19) United States
(12) Patent Application Publication
(10) Pub. No.: US 2020/0073916 A1
(43) Pub. Date: Mar. 5, 2020

(54) COLLABORATIVE DOCUMENTATION

(71) Applicant: INTERNATIONAL BUSINESS MACHINES CORPORATION, ARMONK, NY (US)

(72) Inventors: Jeremy R. Fox, Georgetown, TX (US); Kelley Anders, East New Market, MD (US); Jonathan Dunne, Dungarvan (IE); Liam S. Harpur, Dublin (IE)

(21) Appl. No.: 16/117,031

(22) Filed: Aug. 30, 2018

(51) Int. Cl. G06F 17/21; G06F 17/24

(52) U.S. Cl. CPC G06F 17/212; G06F 17/248

(57) ABSTRACT

According to one or more embodiments, a method, a computer program product, and a computer system for collaborative documentation are provided. The method may include analyzing, by a computer, content associated with one or more documents. Available content associated with the analyzed content may be determined. Required content may be determined, based on the available content. A document framework with one or more design elements may be received, and a new document may be created from this framework. The available content, new content based on the determined missing content, and the design elements may be inserted into the created document. A readability factor associated with the document may be calculated. Based on a determination that the calculated readability factor is greater than a threshold readability value, the document may be transmitted to a user. The transmitted document may contain an identification of the available content and the inserted new content.

### BACKGROUND

The present invention relates generally to field of computers, and more particularly to technical assistance.

A question and solution for a specific technical issue can be made available on social media and forums. For example, a user may have a specific issue and may ask a question based on that issue. One or more other users may provide solutions that address the first user's issue. It may be appreciated that multiple answers may be received, and some of these answers may overlap. Moreover, some of the answers may be missing crucial information for solving the user's issue.

### SUMMARY

Embodiments of the present invention disclose a method, system, and computer program product for collaborative documentation. According to one embodiment, a method for collaborative documentation is provided. The method may include analyzing, by a computer, content associated with one or more documents. Available content associated with the analyzed content may be determined. Required content may be determined, based on the available content. A document framework with one or more design elements may be received, and a new document may be created from this framework. The available content, new content based on the determined missing content, and the design elements may be inserted into the created document. A readability factor associated with the document may be calculated. Based on a determination that the calculated readability factor is greater than a threshold readability value, the document may be transmitted to a user. The transmitted document may contain an identification of the available content and the inserted new content.

According to another embodiment, a computer system for collaborative documentation is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include analyzing, by a computer, content associated with one or more documents. Available content associated with the analyzed content may be determined. Required content may be determined, based on the available content. A document framework with one or more design elements may be received, and a new document may be created from this framework. The available content, new content based on the determined missing content, and the design elements may be inserted into the created document. A readability factor associated with the document may be calculated. Based on a determination that the calculated readability factor is greater than a threshold readability value, the document may be transmitted to a user. The transmitted document may contain an identification of the available content and the inserted new content.

According to yet another embodiment, a computer program product for collaborative documentation is provided. The computer program product may include one or more computer-readable storage devices and program instructions stored on at least one of the one or more tangible storage devices, the program instructions executable by a processor. The program instructions are executable by a processor for performing a method that may accordingly include analyzing, by a computer, content associated with one or more documents. Available content associated with the analyzed content may be determined. Required content may be determined, based on the available content. A document framework with one or more design elements may be received, and a new document may be created from this framework. The available content, new content based on the determined missing content, and the design elements may be inserted into the created document. A readability factor associated with the document may be calculated. Based on a determination that the calculated readability factor is greater than a threshold readability value, the document may be transmitted to a user. The transmitted document may contain an identification of the available content and the inserted new content.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 depicts an exemplary document and topic list according to at least one embodiment;

FIG. 3 is an operational flowchart illustrating the steps carried out by a program for collaborative documentation, according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, according to at least one embodiment; and

FIG. 6 is a block diagram of functional layers of the illustrative cloud computing environment of FIG. 5, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to technical assistance. The following described exemplary embodiments provide a system, method and program product to, among other things, aggregate multiple documents from among a corpus of documents into a single document based on required and available content. Therefore, embodiments of the present invention have the capacity to improve the field of computing by allowing for the creation of a unified solution document in the event a user has a technical issue to which multiple solution documents exist. Thus, the computer-implement method, computer system, and computer program product disclosed herein may, among other things, be used to create a document containing a single solution to a technical issue in order to allow a savings in cost and labor.

As previously described, a question and solution for a specific technical issue can be made available on social media and forums. For example, a user may have a specific issue and may ask a question based on that issue. One or more other users may provide solutions that address the first user's issue. It may be appreciated that multiple answers may be received. Moreover, some of the answers may be missing crucial information for solving the user's issue. It may, therefore, be advantageous to consolidate the multiple answers that may be received and to insert missing required information in order to solve users' technical issues quickly and effectively. Accordingly, the invention disclosed herein may improve the field of computing by providing a system, method, and program product to aggregate multiple documents from among a corpus of documents into a single document based on required and available content.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

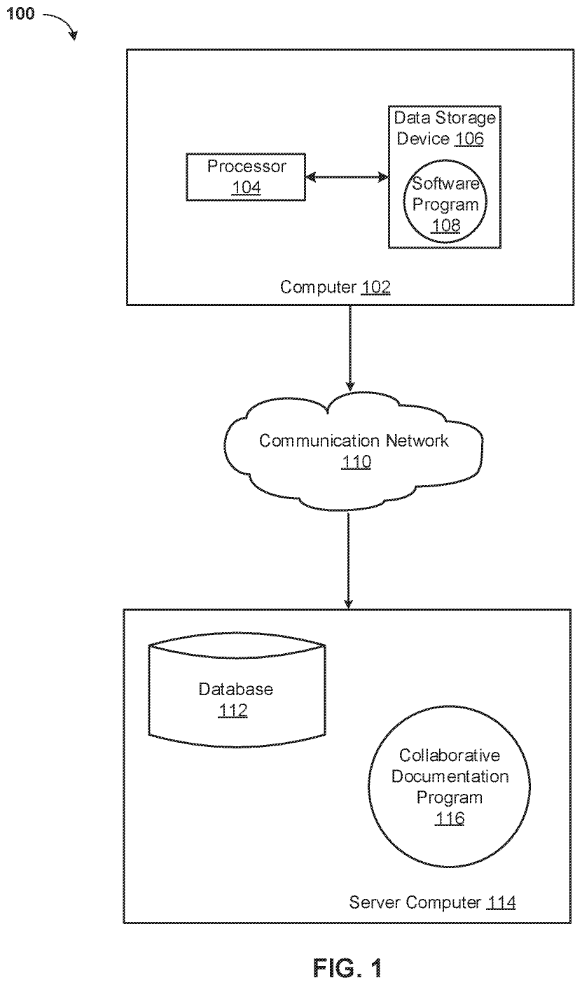

Referring now to FIG. 1, a functional block diagram illustrating a collaborative documentation system 100 for aggregating multiple documents from among a corpus of documents into a single document based on required and available content is shown. It should be appreciated that FIG. 1 provides only an illustration of one implementation and does not imply any limitations with regard to the environments in which different embodiments may be implemented. Many modifications to the depicted environments may be made based on design and implementation requirements.

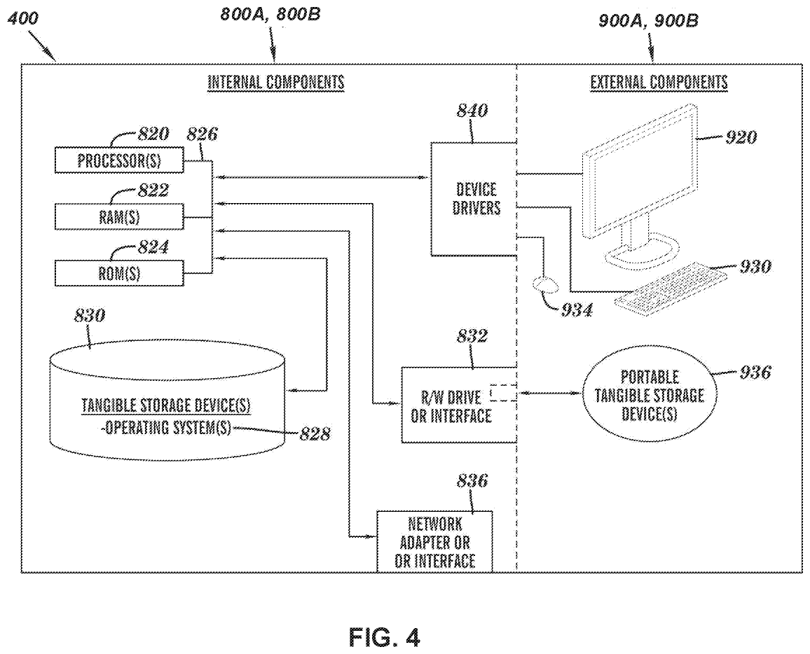

The collaborative documentation system 100 may include a computer 102 and a server computer 114. The computer 102 may communicate with the server computer 114 via a communication network 110. The computer 102 may include a software program 108 that is stored on a data storage device 106 and is enabled to interface with a user and communicate with the server computer 114. As will be discussed below with reference to FIG. 4 the computer 102 may include internal components 800A and external components 900A, respectively, and the server computer 114 may include internal components 800B and external components 900B, respectively. The computer 102 may be, for example, a mobile device, a telephone, a personal digital assistant, a netbook, a laptop computer, a tablet computer, a desktop computer, or any type of computing devices capable of running a program, accessing a network, and accessing a database.

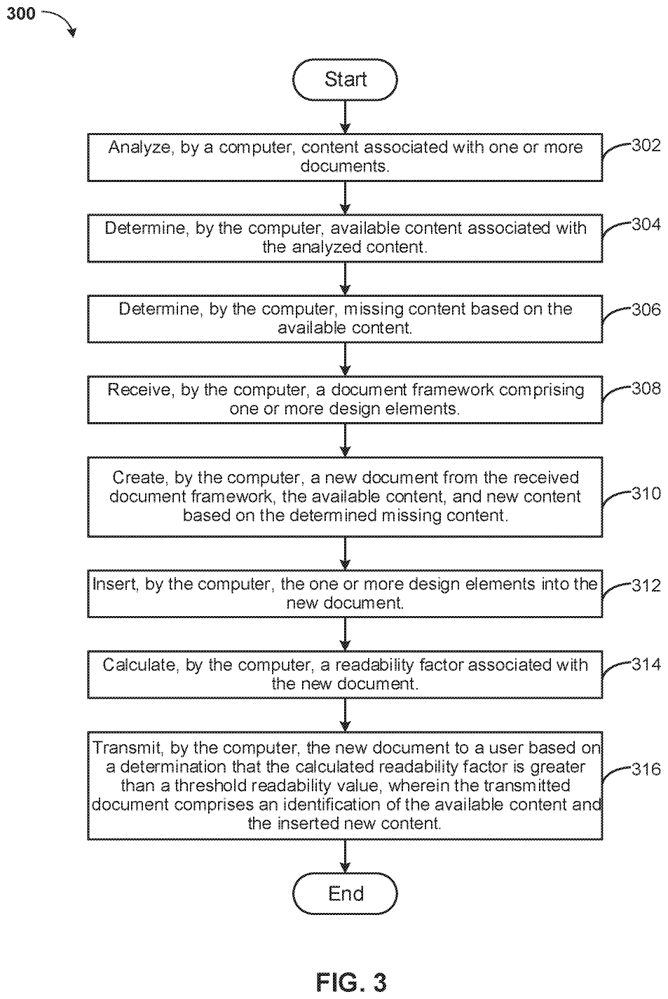

The server computer 114 may also operate in a cloud computing service model, such as Software as a Service (SaaS), Platform as a Service (PaaS), or Infrastructure as a Service (IaaS), as discussed below. The server computer 114 may also be located in a cloud computing deployment model, such as a private cloud, community cloud, public cloud, or hybrid cloud. The server computer 114, which may be used for aggregating multiple documents from among a corpus of documents into a single document based on required and available content, is enabled to run a Collaborative Documentation Program 116 that may interact with a database 112. The Collaborative Documentation Program method is explained in more detail below with respect to FIG. 3. In one embodiment, the computer 102 may operate as an input device including a user interface while the Collaborative Documentation Program 116 may run primarily on server computer 114. In an alternative embodiment, the Collaborative Documentation Program 116 may run primarily on one or more computers 102 while the server computer 114 may be used for processing and storage of data used by the Collaborative Documentation Program 116. It should be noted that the Collaborative Documentation Program 116 may be a standalone program or may be integrated into a larger collaborative documentation program.

It should be noted, however, that processing for the Collaborative Documentation Program 116 may, in some instances be shared amongst the computers 102 and the server computers 114 in any ratio. In another embodiment, the Collaborative Documentation Program 116 may operate on more than one computer, server computer, or some combination of computers and server computers, for example, a plurality of computers 102 communicating across the communication network 110 with a single server computer 114. In another embodiment, for example, the Collaborative Documentation Program 116 may operate on a plurality of server computers 114 communicating across the communication network 110 with a plurality of client computers. Alternatively, the program may operate on a network server communicating across the network with a server and a plurality of client computers.

The communication network 110 may include wired connections, wireless connections, fiber optic connections, or some combination thereof. In general, the communication network 110 can be any combination of connections and protocols that will support communications between the computer 102 and the server computer 114. The communication network 110 may include various types of networks, such as, for example, a local area network (LAN), a wide area network (WAN) such as the Internet, a telecommunication network, a wireless network, a public switched network and/or a satellite network.

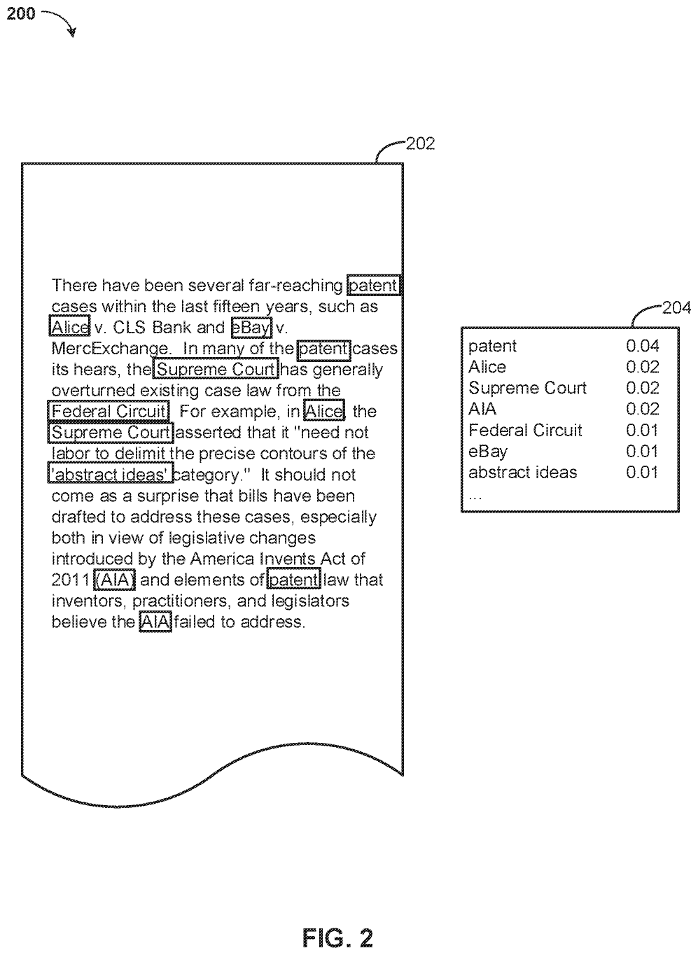

Referring to FIG. 2, an exemplary document 202 and topic list 204 are depicted. The list 204 may contain one or more topics that may be present within the document 202. Additionally, the list 204 may also contain a proportion or frequency associated with the occurrence of the topics within the document 202. The document 202 may be analyzed by the Collaborative Documentation Program 116 (FIG. 1) using one or more modeling techniques in order to determine the content contained in the document, such as latent Dirichlet allocation (LDA), BiTerm topic model, or other similar modeling techniques. In an embodiment, the document 202 may be stored on the database 112 (FIG. 1) on the server computer 114 (FIG. 1). In another embodiment the document 202 may be stored on the data storage device 106 (FIG. 1) on the computer 102 (FIG. 1) and may be accessible to the Collaborative Documentation Program 116 via the communication network 110.

It may be appreciated that for illustration purposes, only one document 202 and one list 204 are depicted. However, the collaborative documentation system 100 may retrieve and analyze any number of documents 202 and create any number of lists 204. In one embodiment, one list 204 may be generated for each document 202. In an alternative embodiment, multiple lists 204 may be generated for each document 202, whereby each list 204 may correspond to a broad topic that contains multiple subtopics corresponding to the broader topic.

Referring now to FIG. 3, an operational flowchart 300 illustrating the steps carried out by a program for collaborative documentation, such as the Collaborative Documentation Program 116, is depicted. FIG. 3 may be described with the aid of FIGS. 1 and 2. As previously described, the Collaborative Documentation Program 116 (FIG. 1) may aggregate multiple documents from among a corpus of documents into a single document based on required and available content.

At 302, content associated with one or more documents is analyzed by a computer. In one embodiment, the one or more documents may be stored within a database on the computer. In another embodiment, the one or more documents may be stored within a database on a server computer. In another embodiment, the one or more documents may be retrieved from the Internet. The documents may each be analyzed using LDA, BiTerm, or another modeling technique in order to model the content of the documents. The content may include topics and a proportion with which the topics may appear in the documents. In operation, the Collaborative Documentation Program 116 (FIG. 1) on the server computer 114 (FIG. 1) may retrieve a document 202 (FIG. 2) from the database 112 (FIG. 1). The Collaborative Documentation Program 116 may analyze the document 202 for topics that may appear within the document 202 and generate a list 204 (FIG. 2) containing the topics found within the document 202. For example, the Collaborative Documentation Program 116 may determine that the document 202 contains topics such as “patent,” “Alice,” and “Supreme Court.” The Collaborative Documentation Program 116 may then include these topics on the list 204 as topics that appear within the document 202 and may, therefore, be used in creating a new document using the content of the document 202.

At 304, available content associated with the analyzed content is determined by the computer. Based on the analysis of content containing one or more topics, the computer may determine that content may be available to be used to create a new document by the computer. In one embodiment, the available content may be content corresponding to topics from among the list 204 (FIG. 2) that meets or exceeds a given frequency threshold. In an alternative embodiment, the available content may be content corresponding to a pre-determined number of topics having a highest frequency. In operation, the Collaborative Documentation Program 116 (FIG. 1) may determine that the list 204 (FIG. 2) has topics that may occur within the document 202 (FIG. 2) with a high frequency, such as “patent” and “Alice.” Therefore, the Collaborative Documentation Program 116 may determine that the document 202 contains patent-related content and that such content is available to be used in creating a new patent-related document.

At 306, missing content is determined by the computer, based on the available content. The missing content may be determined based on an identification that one or more topics from among the available content are not present within the available content. The missing content may be retrieved from either a database on the computer, another computer, or from the Internet. The computer may utilize from certain online publications that are produced with regularity in a digital form as one source for missing content, such as news articles, research journals, blog posts, and the like. In one embodiment, the missing content may include, among other things, topics from among the list 204 (FIG. 2) that do not meet a given threshold value. In another embodiment, missing content may include content that may not be present in the document 202 (FIG. 2) but may, nevertheless, appear concurrently with topics from among the list 204. In operation, the Collaborative Documentation Program 116 (FIG. 1) may determine that a particular topic (for example “judicial exception”) is missing from the list 204 based on the other topics identified on the list 204. For example, the Collaborative Documentation Program 116 (FIG. 1) may determine that “judicial exception” is missing from the list 204 based on the existence/identification of the topic “Alice” and “abstract ideas” among the list 204 (FIG. 2) of topics present in the document 202 (FIG. 2). The Collaborative Documentation Program 116 may then determine that content associated with the topic “judicial exception” in light of “Alice” and “abstract ideas” may be useful in a created new document.

At 308, a document framework with one or more design elements may be received by the computer. The document framework may be a skeletal layout with one or more design elements that may be later used to create a new document. The design elements may include, among other things, one or more graphics (e.g., vector, bitmap, JPEG, PNG, GIF, TIFF, etc.), lists, tables, headings, hyperlinks, page breaks, columns, and any associated formatting, such as font type, size, or rotation. The document framework and corresponding design elements may be based on an organizational standard or may be user-defined based on operational needs of a user, group of users, or organization. For example, the graphics and fonts may correspond to company-specific information, such as logos, color schemes, corporate typefaces, or trademarks. In operation, the Collaborative Documentation Program 116 (FIG. 1) may receive a document framework from which a blank document may later be created and into which the content from the document 202 (FIG. 2) may later be inserted. In one embodiment, the document framework may be retrieved from the database 112 (FIG. 1) on the server computer 114 (FIG. 1). In another embodiment, the document framework may be received from the software program 108 (FIG. 1) on the computer 102 (FIG. 1) via communication network 110 (FIG. 1). In another embodiment, the document framework may be retrieved from the Internet via communication network 110.

At 310, a new document is created by the computer from the received document framework, the available content, and new content. The new document may be a blank document with the ability to receive content from one or more pre-existing documents. The inserted new content may be inserted into the new document in a way that may be compatible with the document framework. The inserted new content may be made available from one or more other documents based on the determined missing content at 306. A content differential model (CDM) may be derived based on the available content and the inserted new content. A percent level of available content for creating the new document based on the available content and the missing content may be determined. The percent level may be used, among other things, to determine a ratio of new content to missing content. The percent level may be pre-determined or may be adjusted based on a user's needs. In operation, the Collaborative Documentation Program 116 (FIG. 1) may create the new document based on the framework received at 308. The new document may be stored in the database 112 (FIG. 1) on the server computer 114 (FIG. 1). In an alternative embodiment, may be stored within the data storage device 106 (FIG. 1) on the computer 102 (FIG. 1). The Collaborative Documentation Program 116 may also insert at least a portion of the content of the document 202 (FIG. 2) into the created new document. In one embodiment, the inserted available content may be based on the list 204 (FIG. 2) of topics within the document 202. In an alternative embodiment, the inserted available content may be all or substantially all of the document 202. The Collaborative Documentation Program 116 may also insert the required “judicial exception” content (see 306) into the created document. In one embodiment, the “judicial exception” content may be retrieved from the database 112. In another embodiment, the “judicial exception” content may be retrieved from the data storage device 106 on the computer 102 via the communication network 110.

At 312, the one or more design elements are inserted into the new document by the computer. As previously discussed, the design elements may include, among other things, one or more graphics (e.g., vector, bitmap, JPEG, PNG, GIF, TIFF, etc.), lists, tables, headings, hyperlinks, page breaks, columns, and any associated formatting, such as font type, size, or rotation. In operation, the Collaborative Documentation Program 116 (FIG. 1) may insert a design element into the created document. According to one embodiment, the design element may be retrieved from the database 112 (FIG. 1). In an alternative embodiment, the design element may be received from the computer 102 (FIG. 1) via the communications network 110 (FIG. 1).

At 314, a readability factor associated with the new document is calculated by the computer. The readability factor may be calculated using one or more methods such as Gunning Fog, Dale-Chall, or another method. This readability score may ensure that the created new document is at least as readable as the available source content from which it was derived. One or more of language, grammar, word-choice, syntax, definitions, and length may be used in calculating the readability score to ensure that content from disparate sources can be assembled in a readable manner. In operation, the Collaborative Documentation Program 116 (FIG. 1) may calculate a readability score for the new document. The Collaborative Documentation Program 116 may calculate the score by calculating one or sub-scores corresponding to language, grammar, word-choice, syntax, definitions, and length. The readability score for the created document may be stored within the database 112 (FIG. 1).

At 316, the new document is transmitted to a user based on a determination that the calculated readability factor is greater than a threshold readability value. The transmitted document comprises an identification of the available content and the inserted new content. The identification of the available and the inserted new content may include, among other things, a hyperlink and a comment associated with the inserted content, a first color associated with the available content and a second color associated with the inserted new content, a first format associated with the available content and a second format associated with the inserted new content, or any choice of user-defined attributes. In operation, the Collaborative Documentation Program 116 (FIG. 1) may transmit the created new document to the computer 102 (FIG. 1) via communication network 110 (FIG. 1) based on a determination that the readability value calculated at 314 is greater than a threshold readability value. In one embodiment, the threshold readability value may be stored on the database 112 (FIG. 1). In an alternative embodiment, the threshold readability value may be provided to the Collaborative Documentation Program 116 from the computer 102 via the communication network 110. In such an alternative embodiment, the threshold readability value may either be entered by the user of the computer 102 or may be retrieved from the data storage device 106 on the computer 102. The transmitted document may be displayed by the software program 108 (FIG. 1) and may contain, for example, the inserted new content highlighted in a given color.

It may be appreciated that FIG. 3 provides only an illustration of one implementation and does not imply any limitations with regard to how different embodiments may be implemented. Many modifications to the depicted environments may be made based on design and implementation requirements.

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Computer 102 (FIG. 1) and server computer 114 (FIG. 1) may include respective sets of internal components 800A,B and external components 900A,B illustrated in FIG. 4. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828, the Software Program 108 (FIG. 1) and the Collaborative Documentation Program 116 (FIG. 1) on server computer 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800A,B also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Collaborative Documentation Program 116 (FIG. 1) can be stored on one or more of the respective portable computer-readable tangible storage devices 936, read via the respective R/W drive or interface 832 and loaded into the respective hard drive 830.

Each set of internal components 800A,B also includes network adapters or interfaces 836 such as a TCP/IP adapter cards; wireless Wi-Fi interface cards; or 3G, 4G, or 5G wireless interface cards or other wired or wireless communication links. The Software Program 108 (FIG. 1) and the Collaborative Documentation Program 116 (FIG. 1) on the server computer 114 (FIG. 1) can be downloaded to the computer 102 (FIG. 1) and server computer 114 from an external computer via a network (for example, the Internet, a local area network or other, wide area network) and respective network adapters or interfaces 836. From the network adapters or interfaces 836, the Software Program 108 and the Collaborative Documentation Program 116 on the server computer 114 are loaded into the respective hard drive 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

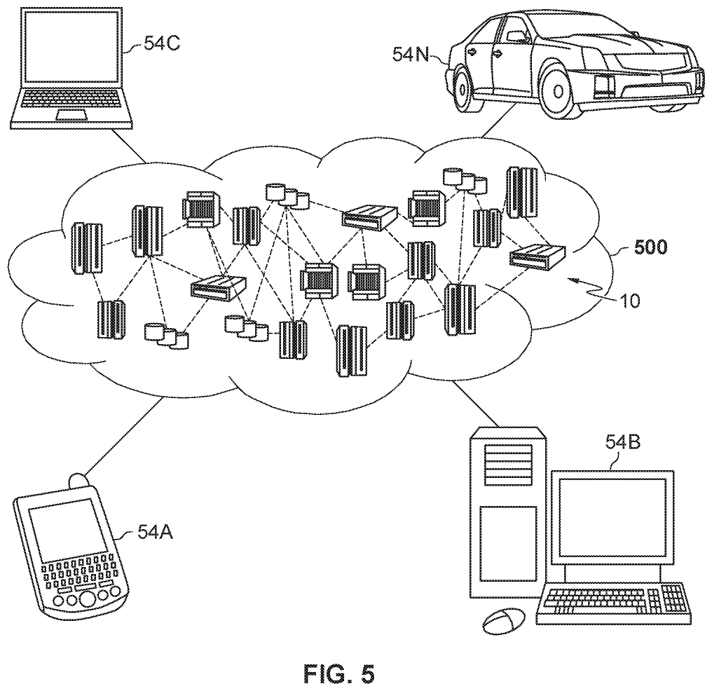

Referring to FIG. 5, illustrative cloud computing environment 500 is depicted. As shown, cloud computing environment 500 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 54A-N shown in FIG. 5 are intended to be illustrative only and that cloud computing nodes 10 and cloud computing environment 500 can communicate with any type of computerized device over any type of network and/or network addressable connection (e.g., using a web browser).

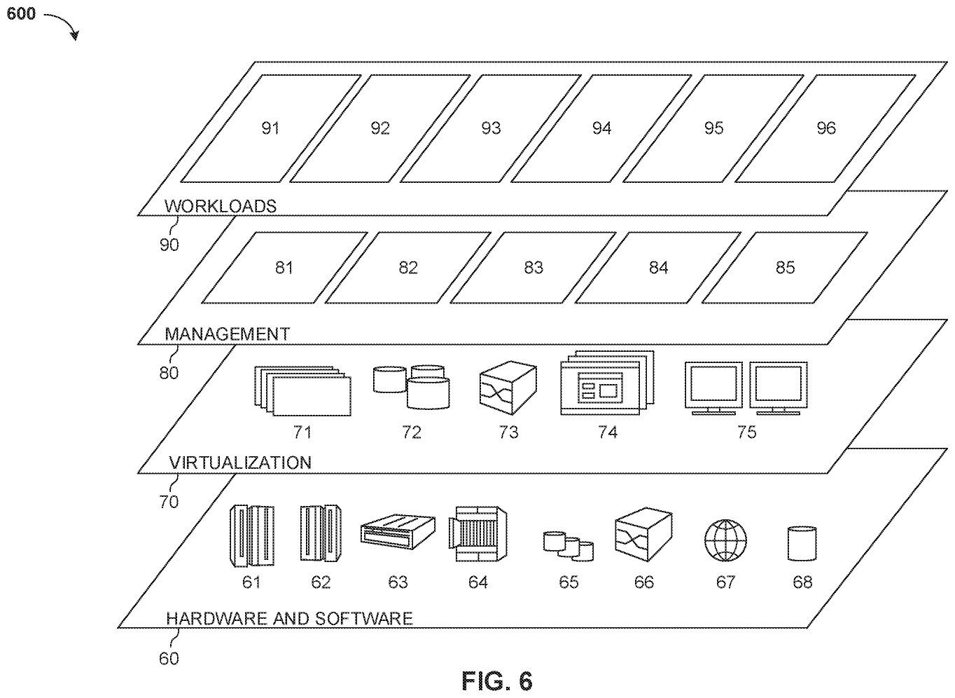

Referring to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Collaborative Documentation 96. Collaborative Documentation 96 may aggregate multiple documents from among a corpus of documents into a single document based on required and available content.

The present invention may be a system, a method, and/or a computer program product at any possible technical detail level of integration. The computer program product may include a computer-readable non-transitory storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of collaborative documentation, the method comprising:
analyzing, by a computer, content associated with one or more documents;
determining, by the computer, available content associated with the analyzed content;
determining, by the computer, missing content based on the available content;
receiving, by the computer, a document framework comprising one or more design elements;
creating, by the computer, a new document from the received document framework, the available content, and new content based on the determined missing content;
inserting, by the computer, the one or more design elements into the new document;
calculate, by the computer, a readability factor associated with the new document; and
transmitting, by the computer, the new document to a user based on a determination that the calculated readability factor is greater than a threshold readability value, wherein the transmitted document comprises an identification of the available content and the inserted new content.

2. The method of claim 1, wherein the analyzing the content associated with the one or more documents comprises modeling using one or more of LDA and BiTerm.

3. The method of claim 1, wherein the calculating the readability factor comprises one or more of Dale-Chall and Gunning-Fog.

4. The method of claim 1, wherein the calculating of the readability factor comprises:
determining a language associated with the new document;
calculating a grammar value associated with the new document;
calculating a word-choice value associated with the new document;
calculating a syntax value associated with the new document;
calculating a definition value associated with the new document; and
calculating a length value associated with the new document.

5. The method of claim 1, wherein the one or more design elements comprises one or more of:
a graphic
a list;
a table;
a heading;
a hyperlink;
a page break;
a rotation factor associated with the inserted content; and
one or more columns associated with the inserted content.

6. The method of claim 1, wherein the identification of the available content and the inserted new content comprises one or more of:
a hyperlink and a comment associated with the inserted content;
a first color associated with the available content and a second color associated with the inserted new content; and
a first format associated with the available content and a second format associated with the inserted new content.

7. The method of claim 6, wherein the identification of the available content and the inserted new content is user-defined.

8. A computer program product for collaborative documentation, the computer program product comprising:
one or more computer-readable storage media and program instructions stored on the one or more computer readable storage media, the program instructions comprising:
program instructions to analyze, by a computer, content associated with one or more documents;
program instructions to determine, by the computer, available content associated with the analyzed content;
program instructions to determine, by the computer, missing content based on the available content;
program instructions to receive, by the computer, a document framework comprising one or more design elements;
program instructions to create, by the computer, a new document from the received document framework, the available content, and new content based on the determined missing content;
program instructions to insert, by the computer, the one or more design elements into the new document;
program instructions to calculate, by the computer, a readability factor associated with the new document; and
program instructions to transmit, by the computer, the new document to a user based on a determination that the calculated readability factor is greater than a threshold readability value, wherein the transmitted document comprises an identification of the available content and the inserted new content.

9. The computer program product of claim 8, wherein the analyzing the content associated with the one or more documents comprises modeling using one or more of LDA and BiTerm.

10. The computer program product of claim 8, wherein the readability factor is calculated using one or more of Dale-Chall and Gunning-Fog.

11. The computer program product of claim 8, wherein the program instructions to calculate of the readability factor comprises:
program instructions to determine a language associated with the new document;
program instructions to calculate a grammar value associated with the new document;
program instructions to calculate a word-choice value associated with the new document;
program instructions to calculate a syntax value associated with the new document;
program instructions to calculate a definition value associated with the new document; and
program instructions to calculate a length value associated with the new document.

12. The computer program product of claim 8, wherein the one or more design elements comprises one or more of:
a graphic
a list;
a table;
a heading;
a hyperlink;
a page break;
a rotation factor associated with the inserted content; and
one or more columns associated with the inserted content.

13. The computer program product of claim 8, wherein the identification of the available content and the inserted new content comprises one or more of:
a hyperlink and a comment associated with the inserted content;
a first color associated with the available content and a second color associated with the inserted new content; and
a first format associated with the available content and a second format associated with the inserted new content.

14. The computer program product of claim 13, wherein the identification of the available content and the inserted new content is user-defined.

15. A computer system for collaborative documentation, the computer system comprising:
one or more computer processors, one or more computer-readable storage media, and program instructions stored on the one or more computer-readable storage media for execution by at least one of the one or more computer processors, the program instructions comprising:
program instructions to analyze, by a computer, content associated with one or more documents;
program instructions to determine, by the computer, available content associated with the analyzed content;
program instructions to determine, by the computer, missing content based on the available content;
program instructions to receive, by the computer, a document framework comprising one or more design elements;
program instructions to create, by the computer, a new document from the received document framework, the available content, and new content based on the determined missing content;
program instructions to insert, by the computer, the one or more design elements into the new document;
program instructions to calculate, by the computer, a readability factor associated with the new document; and
program instructions to transmit, by the computer, the new document to a user based on a determination that the calculated readability factor is greater than a threshold readability value, wherein the transmitted document comprises an identification of the available content and the inserted new content.

16. The computer system of claim 15, wherein the analyzing the content associated with the one or more documents comprises modeling using one or more of LDA and BiTerm.

17. The computer system of claim 15, wherein the readability factor is calculated using one or more of Dale-Chall and Gunning-Fog.

18. The computer system of claim 15, wherein the calculating of the readability factor comprises:
determining a language associated with the new document;
calculating a grammar value associated with the new document;
calculating a word-choice value associated with the new document;
calculating a syntax value associated with the new document;
calculating a definition value associated with the new document; and
calculating a length value associated with the new document.

19. The computer system of claim 15, wherein the one or more design elements comprises one or more of:
a graphic
a list;
a table;
a heading;
a hyperlink;
a page break;
a rotation factor associated with the inserted content; and
one or more columns associated with the inserted content.

20. The computer system of claim 15, wherein the identification of the available content and the inserted new content comprises one or more of:
a hyperlink and a comment associated with the inserted content;
a first color associated with the available content and a second color associated with the inserted new content; and
a first format associated with the available content and a second format associated with the inserted new content.
